(19) United States
(12) Patent Application Publication
(10) Pub. No.: US 2005/0138251 A1
(43) Pub. Date: Jun. 23, 2005

(54) Arbitration of asynchronous and isochronous requests

(76) Inventor: Blaise B. Fanning, Folsom, CA (US)

Correspondence Address: INTEL CORPORATION, P.O. BOX 5326, SANTA CLARA, CA, 95056-5326, US

(21) Appl. No.: 10/740,738

(22) Filed: Dec. 18, 2003

(51) Int. Cl. G06F 13/00

(52) U.S. Cl. 710/107; 710/36

(57) ABSTRACT

Machine-readable media, methods, and apparatus are described to arbitrate between asynchronous requests and isochronous requests. In one embodiment, an arbiter defines a service period comprising an asynchronous portion followed by an isochronous portion. During the asynchronous portion, the arbiter first services asynchronous requests and then services isochronous requests if no asynchronous requests are available. In response to servicing an isochronous request during the asynchronous portion, the arbiter lengthens the asynchronous portion and shortens the isochronous portion for the current service period. During the isochronous portion, the arbiter services isochronous requests and does not service asynchronous requests.

### BACKGROUND

A computing environment may support asynchronous transfers and isochronous transfers. Isochronous transfers may be associated with video, audio, telephony, and/or other applications having guaranteed bandwidth and latency requirements for high quality service. In general, isochronous transfers may transfer a specific number of data units during each isochronous period and may require that the transfer of the specific number of data units be completed within a specified amount of time. In contrast, asynchronous transfers may transfer data of various sized units in a non-uniform manner and may only require that the transfers be completed without specifying a time limit for completion.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing device comprising a memory controller.

FIG. 2 illustrates aspects of an arbitration scheme that may be used by the memory controller of FIG. 1.

FIG. 3 illustrates an embodiment of an arbitration scheme that may be used by the memory controller of FIG. 1.

FIG. 4 illustrates another embodiment of an arbitration scheme that may be used by the memory controller of FIG. 1.

FIG. 5 illustrates an embodiment of a method of configuring a memory controller to arbitrate between asynchronous requests and isochronous requests.

FIG. 6 illustrates an embodiment of a method of arbitrating between asynchronous requests and isochronous requests.

FIG. 7 illustrates another embodiment of a method of arbitrating between asynchronous requests and isochronous requests.

### DETAILED DESCRIPTION

The following description describes techniques for arbitrating between asynchronous and isochronous requests. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

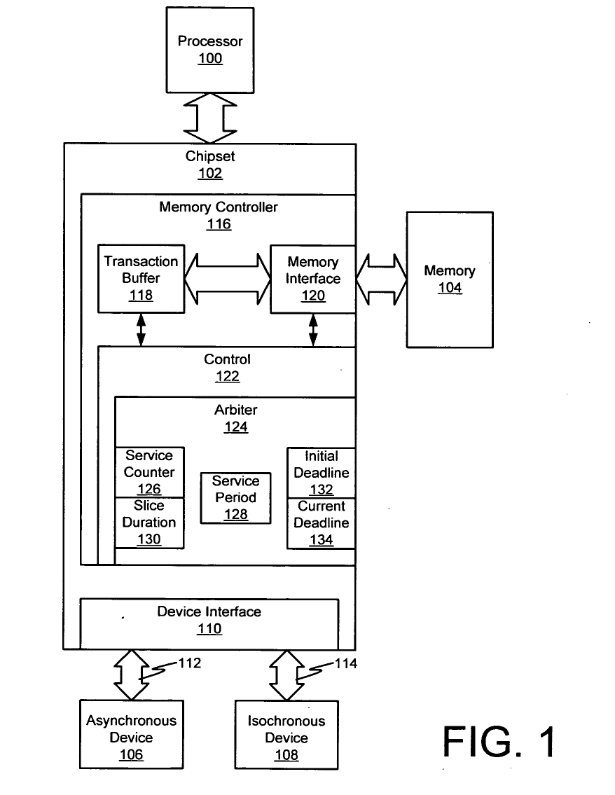

Now referring to FIG. 1, there is shown an embodiment of a computing device. The computing device may comprise a processor 100, a chipset 102, and memory 104. The processor 100 may retrieve and execute instructions from the memory 104. Further, the processor 100 may read data from the memory 104 and write data to the memory 104.

The chipset 102 may include one or more integrated circuit packages or chips that couple the processor 100 to the memory 104, asynchronous devices 106, and isochronous devices 108. The isochronous devices 108 may comprise video, audio, and/or other kinds of time-sensitive devices that generally have guaranteed bandwidth and latency requirements. On the other hand, the asynchronous devices 106 may include devices such as network interfaces, keyboards, mice, or other non-time-sensitive devices. In the depicted embodiment of FIG. 1, the devices 106, 108 are external to the chipset 102; however, in other embodiments the chipset 102 may comprise one or more integrated devices 106, 108.

The chipset 102 may further comprise one or more device interfaces 110 that operably interface the asynchronous devices 106 and the isochronous devices 108 to the chipset 102. In one embodiment, the device interfaces 110 may establish an asynchronous virtual channel 112 with each asynchronous device 106 coupled to the device interface 110 and may establish an isochronous virtual channel 114 with each isochronous device 108 coupled to the device interface 110. In one embodiment, the device interfaces 110 may comprise PCI Express ports capable of establishing asynchronous and isochronous channels. Details concerning PCI Express ports may be found in the PCI Express Base Specification, Rev. 1.0a. Further, the device interfaces 110 may send and receive isochronous requests via the established isochronous channels 114 while maintaining bandwidth and latency requirements of the isochronous requests. Conversely, the device interfaces 110 may send and receive asynchronous requests via the established asynchronous channels 112 without the same bandwidth and latency concerns as the isochronous requests.

A device, however, may be an asynchronous device 106 and/or isochronous device 108 depending upon the nature of its use. For example, a network interface may be an asynchronous device 106 when used to transfer web pages of a web server, but may be an isochronous device 108 when streaming audio to an audio client for real-time playback. In such a situation, the device interface 110 may establish an asynchronous channel with the network interface to support asynchronous transfers of the web page data between the chipset 102 and the network interface. Further, the device interface 110 may establish an isochronous channel with the network interface to support isochronous transfers of audio stream data between the chipset 102 and the network interface.

To simplify the following discussion of isochronous contracts, the device interface 110 may be the completer and the isochronous device 108 may be the requester. However, depending upon the nature of the transfer, the roles may be reversed with the device interface 110 being the requester and the isochronous device 108 being the completer.

In one embodiment, the completer and the requester may establish an isochronous contract for their virtual isochronous channel. In particular, the requester may require a specified number N of transactions of a specified maximum payload size Y within a specified isochronous time period T. The bandwidth required by the requester therefore may be determined from the following formula: BW=(N*Y)/T. Further, the requester may require that the completer complete each transaction within a specified latency L. Once committed to the contract, the completer guarantees to provide the requester with the bandwidth and latency of the contract and the requester agrees to conform to consume no more than the requested bandwidth per isochronous time period T.

The chipset 102 may also comprise a memory controller 116 to read data from and/or write data to the memory 104 in response to read and write requests of the processor 100, the asynchronous devices 106, and the isochronous devices 108. The memory 104 may comprise one or more memory devices that provide addressable storage locations from which data and instructions may be read and/or to which data and instructions may be written. The memory 104 may also comprise one or more different types of memory devices such as, for example, DRAM (Dynamic Random Access Memory) devices, SDRAM (Synchronous DRAM) devices, DDR (Double Data Rate) SDRAM devices, or other volatile and/or non-volatile memory devices.

As depicted, the memory controller 116 may comprise a buffer 118, a memory interface 120, and a controller 122. The buffer 118 may store or buffer asynchronous and isochronous requests of the processor 100 and devices 106, 108. The memory interface 120 under the direction of the controller 122 may satisfy the requests of the buffer 118. In particular, the memory interface 120 may generate control signals to write data of a write request to the memory 104 and may generate control signals to read data of a read request from the memory 104.

The controller 122 may control the buffer 118 and the memory interface 120. In particular, the controller 122 in one embodiment may select requests of the buffer 118 for the memory interface 120 to service. To this end, the controller 122 may comprise an arbiter 124 that determines when the memory interface 120 is to service an asynchronous request of the buffer 118 and when the memory interface 120 is to service an isochronous request of the buffer 118. In one embodiment, the arbiter 124 may comprise a service counter 126, a service period register 128, slice duration register 130, a initial deadline register 132, and a current deadline register 134.

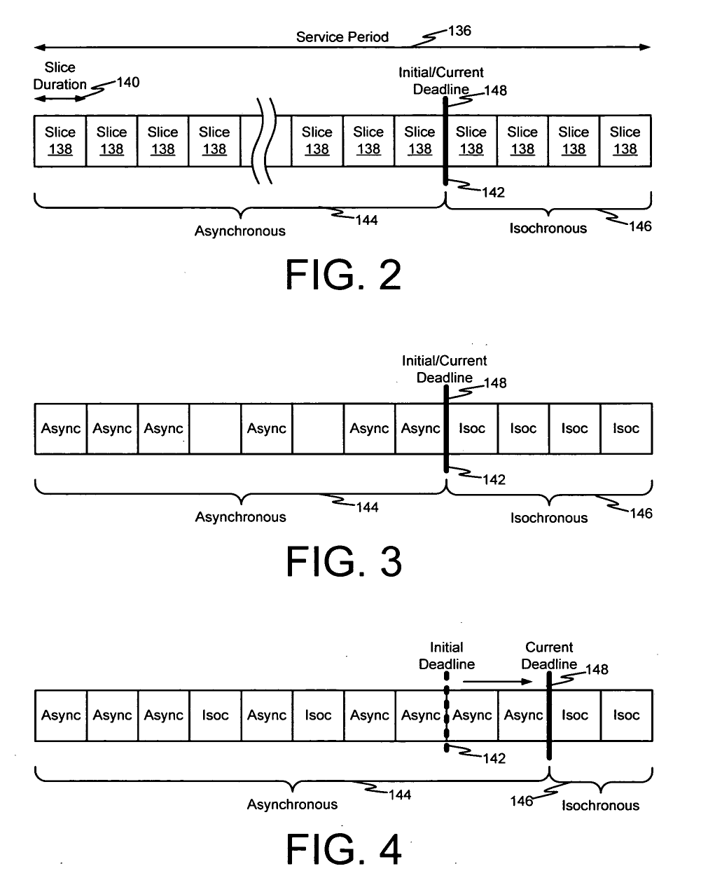

With reference to FIG. 2, the service period register 128 may define duration of a service period 136. In one embodiment, the service period register 128 may define the service period 136 as a number of slices 138. In another embodiment, the service period register 128 may define the service period 136 as a number of clock cycles of a clock signal. The service counter 126 may track a position of the arbiter 124 in the service period 136. The slice duration register 130 may define the duration 140 of each slice 138 of the service period 136. In one embodiment, the slice duration register 130 may define the duration 140 as a number of clock cycles. The initial deadline register 132 may define the deadline 142 of the service period 136 at the start of the service period 136 and may divide the service period 136 into an asynchronous portion 144 and an isochronous portion 146. The current deadline register 134 may define the current deadline 148 that divides the service period 136 into an asynchronous portion 144 and an isochronous portion 146. The current deadline 148 may be adjusted from the initial deadline 142 in response to servicing isochronous requests during the asynchronous portion 144 of the service period 136.

A service period 136 may comprise a plurality of slices 138. Further, a deadline 148 may divide the service period 136 into an asynchronous portion 146 and an isochronous portion 146. In one embodiment, the arbiter 124 may select only asynchronous requests for the memory interface 120 to service during the slices 138 of the asynchronous portion 144 and may select only isochronous requests for the memory interface 120 to service during the slices 138 of the isochronous portion 146. The deadline 148 therefore essentially reserves a portion of the service period 136 for isochronous requests. Accordingly, the arbiter 124 may set the deadline 148 such that memory interface 120, during the service period 136, services all isochronous requests that need to be serviced in order to satisfy the isochronous contracts of the computing device.

A manner by which an embodiment of the arbiter 124 may select requests of a specific series of requests for a memory interface 120 to service is shown in FIG. 3. As depicted, the arbiter 124 may allocate twelve slices 138 to a service period 136. Further, the arbiter 124 may set the deadline 148 to reserve the last four slices 138 of a service period 136 for isochronous requests, thus leaving the first eight slices 138 for asynchronous requests. During the asynchronous portion 144 of the service period 136, the arbiter 124 may select asynchronous requests of the buffer 118 for the memory interface 120 to service. During the isochronous portion 146 of the service 136, the arbiter 124 may select isochronous requests of the buffer 118 for the memory interface 120 to service. However, as depicted, the buffer 118 at times may not have pending asynchronous requests thus resulting in two of the asynchronous slices 138 going unused.

A manner by which another embodiment of the arbiter 124 may select requests of the same specific series of requests for the memory interface 120 to service is shown in FIG. 4. Again, the arbiter 124 may allocate twelve slices 138 to the service period 136, and may set the deadline 148 to reserve the last four slices 138 of a service period 136 for isochronous requests. However, during the slices 138 of the asynchronous portion 144, the arbiter 124 may assign a higher priority to asynchronous requests than isochronous requests. Accordingly, the arbiter 124 during the asynchronous slices 138 may select, in addition to asynchronous requests, isochronous requests of the buffer 118 for the memory interface 120 to service when the buffer 118 has no pending asynchronous requests. As a result, the two asynchronous slices 138 that went unused in FIG. 3 may be used in FIG. 4 to service isochronous requests.

In response to using an asynchronous slice 138 for a isochronous request, the arbiter 124 may update the deadline 148. In particular, the arbiter 124 in one embodiment may move the deadline 148 from the initial deadline 142 toward the end of the service period 136 by one slice 138 for each asynchronous slice 138 used for an isochronous request. Updating the deadline 148 may ensure that the memory controller 116 uses the same bandwidth for isochronous requests during each service period 136 regardless of whether an isochronous request was serviced during the asynchronous portion 144 of the service period 136. Further, updating the deadline 148 may enable the arbiter 124 to allocate an asynchronous request to a slice 138 that had previously been reserved for an isochronous request. Thus, as illustrated, the arbiter 124 of FIG. 4 may be able to utilize all of the slices 138 of the service period 136 while maintaining isochronous requirements of the computing device.

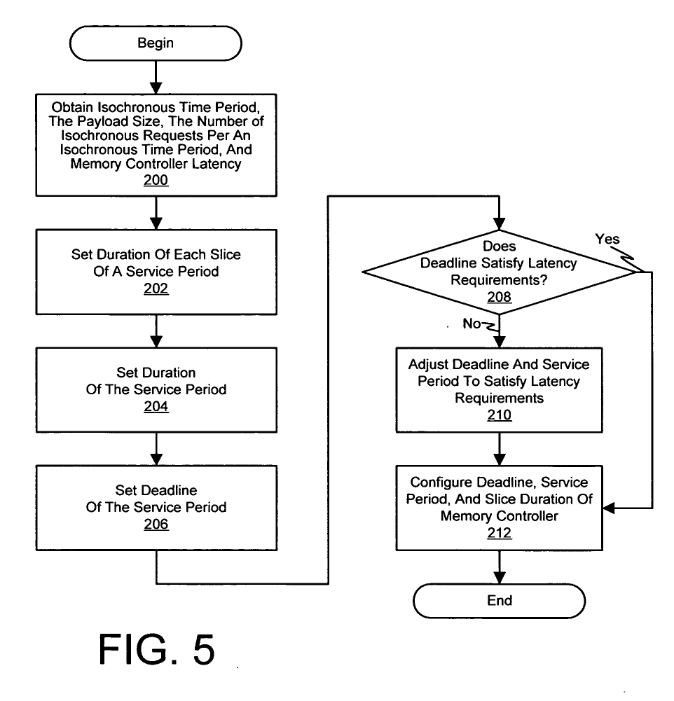

Referring now to FIG. 5, a method of configuring the memory controller 116 to arbitrate between asynchronous and isochronous requests is shown. The processor 100 in block 200 may obtain the shortest isochronous time period T, the maximum payload size Y, and the number of isochronous requests N per an isochronous time period T required by the isochronous channels of the computing device. Further, the processor 100 may obtain a memory controller latency requirement L_{mc} that indicates the maximum time the memory controller 116 may take to start and complete a isochronous request of the buffer 118. In one embodiment, the processor 100 may update the shortest isochronous time period T and the maximum payload size Y during initialization of each isochronous channel. In another embodiment, the computing device may support a single isochronous time period T and a single payload size Y. Accordingly, the processor 100 may obtain such parameters during system boot and/or from an operating system of the computing device. Further, the processor 100 may determine, based upon the contracts of the isochronous channels, the memory controller latency requirement L_{mc} and the number N of isochronous requests that the memory controller 116 must service per an isochronous time period T in order to satisfy the latency and bandwidth requirements of the isochronous channels.

In block 202, the processor 100 may set the duration of each slice 138 of the service period 136. In one embodiment, the processor 100 may set the duration 140 of each slice 138 to a worse-case time for the memory interface 120 to start and complete an isochronous request of the memory buffer 118. In one embodiment, the processor 100 may determine the worse-case time for the memory controller 120 based upon a register of the memory controller 116.

In block 204, the processor 100 may set the duration service period 136. In one embodiment, the processor 100 may define the duration of the service period 136 by a number Nₛ of slices 138 that comprise the service period 136. In particular, the processor 100 may divide the isochronous time period T by the duration 140 of each slice 138 to obtain the number Nₛ of slices 138 for the service period 136. In one embodiment, the processor 100 may use an integer divide so as to arrive at an integer value for the number Nₛ and a service period 136 that is less than or equal to the isochronous period T.

The processor 100 in block 206 may set the deadline 148 such that it reserves the last N slices of the service period 138 for the N isochronous requests that the memory controller 116 is required to service during the isochronous time period T. In one embodiment, the processor 100 may further determine in block 208 whether the deadline 148 complies with the memory controller latency requirements L_{mc}. In particular, the processor 100 may ensure that the duration of the asynchronous portion 144 is not greater than the isochronous latency requirement L_{mc} of the memory controller 116.

In response to determining that the duration of the asynchronous portion 144 is greater than the latency requirements L_{mc} for the memory controller 116, the processor 100 in block 210 may adjust the service period 136 and deadline 148. In particular, the processor 100 in one embodiment may divide the service period 136 by an integer rounding down and may divide the number Nₛ of isochronous slices by the same integer but rounding up. For example, the processor 100 may divide the a seventeen slice service period 136 having three isochronous slices by two to obtain a new eight slice service period having two isochronous slices. As a result, the worst-case latency for isochronous slices has been reduced from fourteen slices in the seventeen slice service period to six slices in the eight slice service period 136.

In block 212, the processor 100 may configure the memory controller 116 to service isochronous requests based upon the determined service period 136 and deadline 148. In one embodiment, the processor 100 may one or more values to the memory controller 116 that result in the memory controller 116 servicing isochronous requests using the service period 136, the deadline 148, and the slice duration 140. In particular, the processor 100 in one embodiment may update the service period register 128 to indicate the duration of the service period 136, may update the slice duration register 130 to indicate the duration of each slice 138 of the service period 136, and may update the initial deadline 142 and the current deadline register 148 to divide the service period 136 into an asynchronous portion 144 and an isochronous portion 146.

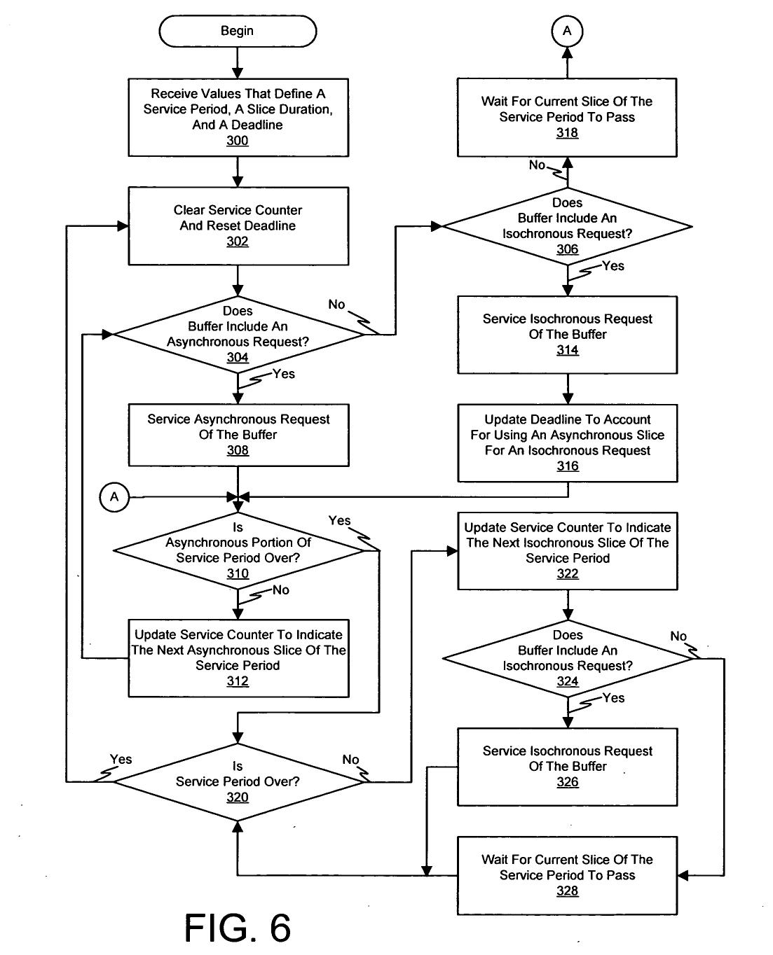

A method of arbitrating between asynchronous requests and isochronous requests is shown in FIG. 6. The arbiter 124 in block 300 may receive values from the processor 100 that define a service period 136, a slice duration 140, and a deadline 148. In response to receiving the values, the arbiter 124 in block 302 may clear its service counter 126 to indicate that the arbiter 124 is at the beginning of the service period 136 and may set its current deadline register 134 to the value of the initial deadline register 132 to reset the current deadline 148 to the initial deadline 142 for the service period 136. In one embodiment, the arbiter 124 may define the service period 136 and the deadline 148 based upon a number of slices 138 and may update its service counter 126 to indicate the current slice of the service period 136. For example, the arbiter 124 may define the service period 136 as having sixteen slices and the deadline 148 as slice fourteen thus reserving slices fifteen and sixteen for isochronous requests. Further, a value of 0 in the service counter 126 may indicate that the current slice is the first slice of the service period 136 whereas a value of fifteen may indicate that the current slice is the sixteenth slice of the service period 136.

In block 304, the arbiter 124 may determine whether the buffer 118 comprises an asynchronous request to service during an asynchronous slice 138 of the service period 144. In response to determining that the buffer 118 does not comprise an asynchronous request to service during the asynchronous slice 138, the arbiter 124 in block 306 may determine whether the buffer 118 comprises an isochronous request to service during the same asynchronous slice 138.

In response to determining in block 304 that the buffer comprises an asynchronous request to service, the arbiter 124 may cause the memory interface 120 in block 308 to service the next asynchronous request of the buffer 118 during the asynchronous slice 138. The arbiter 124 in block 310 may then determine based upon the deadline 148 whether the asynchronous portion 144 is over and the isochronous portion 146 is beginning. In an embodiment, the arbiter 124 may determine that the isochronous portion 146 is beginning in response to determining that the value of the service counter 126 has a predetermined relationship (e.g. equal to) the deadline 148. In response to determining that the asynchronous portion 144 is not over and the isochronous portion 146 is not beginning, the arbiter 124 may then update the service counter 126 in block 312 to advance the arbiter 124 to the next slice 138 of the asynchronous portion 144. After updating the service counter 126, the arbiter 124 may return to block 304 to process another slice 138 of the asynchronous portion 144.

In response to determining that the buffer 118 comprises an isochronous request in block 306, the arbiter 124 may cause the memory interface 120 in block 314 to service the next isochronous request of the buffer 118 during the asynchronous slice 138. The arbiter 124 in block 316 may then update the deadline 148 to reflect the fact that an isochronous request was serviced during the asynchronous portion 144 of the service period 136. In particular, the arbiter 124 in one embodiment may increment the current deadline register 134 by one but not past the end of the service period 136 to effectively move a slice of the isochronous portion 146 to the asynchronous portion 144 of the service period 136. The arbiter 124 in block 310 may then determine based upon the deadline 148 of the current deadline register 134 whether the asynchronous portion 144 is over and the isochronous portion 146 is beginning. In response to determining that the asynchronous portion 144 is not over and the isochronous portion 146 is not beginning, the arbiter 124 may then update the service counter 126 in block 312 to advance the arbiter 124 to the next slice 138 of the asynchronous portion 144. After updating the service counter 126, the arbiter 124 may return to block 304 to process another slice 138 of the asynchronous portion 144.

In response to determining that the buffer 118 does not comprise a request to service during the asynchronous slice 138, the arbiter 124 may cause the memory interface 120 to service no request thus allowing a slice 138 of the asynchronous portion 144 to go unused. In particular, the arbiter 124 in block 318 may wait for the current slice 138 to pass. The arbiter 124 in block 310 may then determine based upon the deadline 148 whether the asynchronous portion 144 is over and the isochronous portion 146 is beginning. In response to determining that the asynchronous portion 144 is not over and the isochronous portion 146 is not beginning, the arbiter 124 may then update the service counter 126 in block 312 to advance the arbiter 124 to the next slice 138 of the asynchronous portion 144. After updating the service counter 126, the arbiter 124 may return to block 304 to process another slice 138 of the asynchronous portion 144.

In response to determining that the asynchronous portion is over in block 310, the arbiter 124 may determine in block 320 whether the service period 136 is over. In one embodiment, the arbiter 124 may determine that the service period 136 is over in response to determining that the service counter 126 has a predetermined relationship (e.g. equal to) the number Nₛ of slices 138 that comprise the service period 136. In response to determining that the service period 136 is over, the arbiter 124 may return to block 302 to clear the service counter 126 and start the next service period 136.

Otherwise, the arbiter 124 may update the service counter 126 in block 322 to advance the arbiter 124 to the next slice 138 of the isochronous portion 146. After updating the service counter 126, the arbiter 124 may determine in block 324 whether the buffer 118 comprises an isochronous request to service for the slice 138 of the isochronous period 146. In response to determining that the buffer 118 does not comprise an isochronous request for slice 138, the arbiter 124 may cause the memory interface 120 to service no request for slice 138 thus allowing a slice 138 of the isochronous portion 146 to go unused.

In response to determining that the buffer 118 comprises an isochronous request in block 324, the arbiter 124 may cause the memory interface 120 in block 326 to service the next isochronous request of the buffer 118 during the isochronous slice 138. The arbiter 124 may then return to block 320 to determine whether the service period 136 is over. Otherwise, in response to determining that the buffer 118 does not comprise an isochronous request, the arbiter 124 may cause the memory interface 120 to service no request thus allowing a slice 138 of the asynchronous portion 144 to go unused. In particular, the arbiter 124 in block 328 may wait for the current slice 138 to pass and then may return to block 320 to determine whether the current service period 136 is over.

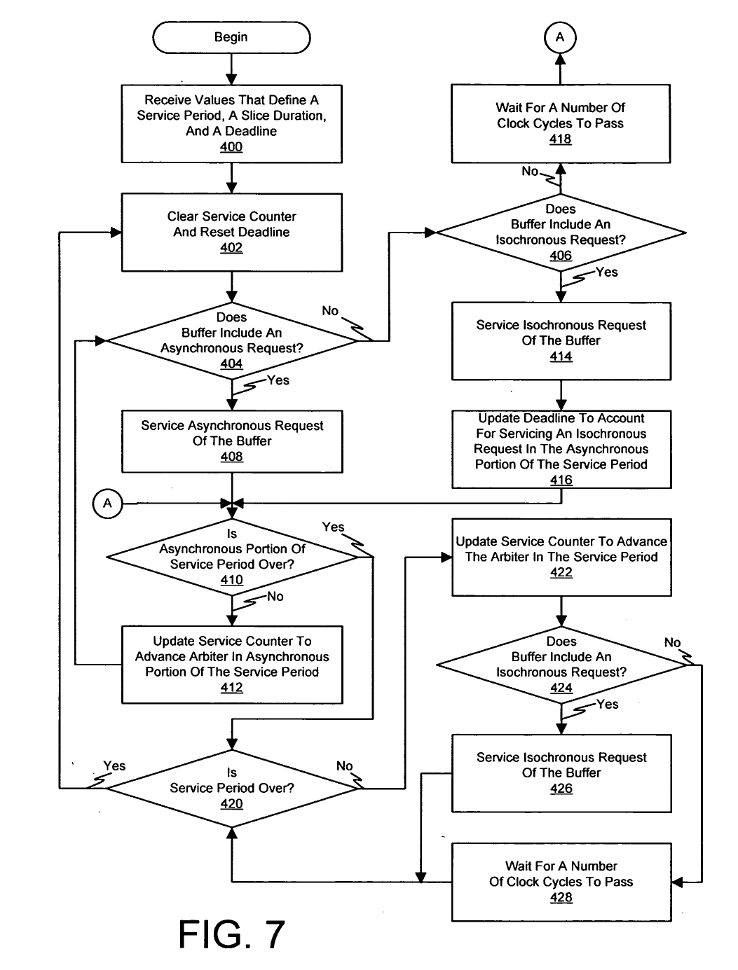

Another method of arbitrating between asynchronous requests and isochronous requests is shown in FIG. 7. The arbiter 124 in block 400 may receive values from the processor 100 that define a service period 136, a slice duration 140, and a deadline 148. In response to receiving the values, the arbiter 124 in block 402 may clear its service counter 126 to indicate that the arbiter 124 is at the beginning of the service period 136 and may set its current deadline register 134 to the value of the initial deadline register 132 to reset the current deadline 148 to the initial deadline 142 for the service period 136. In one embodiment, the arbiter 124 may define the service period 136 and the deadline 148 based upon clock cycles of a clock signal CLK. For example, the arbiter may define the service period 136 as having clock cycles 0 through 1023, may define the slice duration 140 as having thirty-two clock cycles, and may define the deadline 148 as clock cycle 767 of the service period 136 thus reserving clock cycles 768 through 1023 for isochronous requests.

In block 404, the arbiter 124 may determine whether the buffer 118 comprises an asynchronous request to service during the asynchronous portion 144 of the service period 144. In response to determining that the buffer 118 does not comprise an asynchronous request to service during the asynchronous portion 144, the arbiter 124 in block 406 may determine whether the buffer 118 comprises an isochronous request to service during the asynchronous portion 144 of the service period 136.

In response to determining in block 404 that the buffer comprises an asynchronous request to service, the arbiter 124 may cause the memory interface 120 in block 408 to service the next asynchronous request of the buffer 118 during the asynchronous slice 138. The arbiter 124 in block 410 may then determine based upon the deadline 148 whether the asynchronous portion 144 is over and the isochronous portion 146 is beginning. In one embodiment, the arbiter 124 may determine that the asynchronous portion 144 is over in response to determining that the service counter 126 plus the slice duration 140 has a predetermined relationship (e.g. greater than) to the clock cycle (e.g. 767) of the deadline 148. In another embodiment, the arbiter 124 may determine that the asynchronous portion 144 is over in response to determining that the service counter 126 plus the shortest number of clock cycles in which a request may be serviced has a predetermined relationship (e.g. greater than) to the clock cycle of the deadline 148.

In response to determining that the asynchronous portion 144 is not over and the isochronous portion 146 is not beginning, the arbiter 124 may then update the service counter 126 in block 412 to account for the duration of the serviced asynchronous request. In one embodiment, the arbiter 124 may update the service counter 126 by incrementing the value of the service counter 126 by the slice duration 140. In another embodiment, the arbiter may update the service counter 126 by incrementing the value of the service counter 126 by the number of clock cycles the memory interface 120 consumed in servicing the asynchronous request. After updating the service counter 126, the arbiter 124 may return to block 404 to process another request during the asynchronous portion 144.

In response to determining that the buffer 118 comprises an isochronous request in block 406, the arbiter 124 may cause the memory interface 120 in block 414 to service the next isochronous request of the buffer 118 during the asynchronous portion 144 of the service period 136. The arbiter 124 in block 416 may then update the deadline 148 to reflect the fact that an isochronous request was serviced during the asynchronous portion 144 of the service period 136. In particular, the arbiter 124 in one embodiment may increment the current deadline register 134 by the number of clock cycles in the slice duration 140 but not past the clock cycle (e.g. 1023) associated with the end of the service period 136. The arbiter 124 in block 410 may then determine based upon the deadline 148 of the current deadline register 148 whether the asynchronous portion 144 is over and the isochronous portion 146 is beginning. In response to determining that the asynchronous portion 144 is not over and the isochronous portion 146 is not beginning, the arbiter 124 may then update the service counter 126 in block 412 to account for the duration of the serviced isochronous request. After updating the service counter 126, the arbiter 124 may return to block 404 to process another slice 138 of the asynchronous portion 144.

In response to determining that the buffer 118 does not comprise a request to service, the arbiter 124 may cause the memory interface 120 to service no request during the current clock cycle thus allowing one or more clock cycles of the asynchronous portion 144 to go unused. In particular, the arbiter 124 in block 418 may wait for a predetermined number (e.g. 2) of clock cycles to pass. The arbiter 124 in block 410 may then determine based upon the deadline 148 whether the asynchronous portion 144 is over and the isochronous portion 146 is beginning. In response to determining that the asynchronous portion 144 is not over and the isochronous portion 146 is not beginning, the arbiter 124 may then update the service counter 126 in block 412 by the predetermined number cycles that passed in block 418 to advance the arbiter 124 in the asynchronous portion 144. After updating the service counter 126, the arbiter 124 may return to block 404 to process another request during the asynchronous portion 144.

In response to determining that the asynchronous portion is over in block 410, the arbiter 124 may determine in block 420 whether the service period 136 is over. In one embodiment, the arbiter 124 may determine that the service period 136 is over in response to determining that the service counter 126 plus the slice duration 140 has a predetermined relationship (e.g. greater than) to the clock cycle (e.g. 1023) associated with the end of the service period 136. In another embodiment, the arbiter 124 may determine that the asynchronous portion 144 is over in response to determining that the service counter 126 plus the shortest number of clock cycles in which a request may be serviced has a predetermined relationship (e.g. greater than) to the clock cycle associated with the end of the service period 136. In response to determining that the service period 136 is over, the arbiter 124 may return to block 402 to clear the service counter 126 and start the next service period 136.

Otherwise, the arbiter 124 may update the service counter 126 in block 422 to account for the duration of the serviced isochronous request. In one embodiment, the arbiter 124 may update the service counter 126 by adding the slice duration 140 in clock cycles to the value of the service counter 126. After updating the service counter 126, the arbiter 124 may determine in block 424 whether the buffer 118 comprises an isochronous request to service for the slice 138 of the isochronous period 146. In response to determining that the buffer 118 does not comprise an isochronous request for slice 138, the arbiter 124 may cause the memory interface 120 to service no request for slice 138 thus allowing a slice 138 of the isochronous portion 146 to go unused.

In response to determining that the buffer 118 comprises an isochronous request in block 424, the arbiter 124 may cause the memory interface 120 in block 426 to service the next isochronous request of the buffer 118 during the isochronous slice 138. The arbiter 124 may then return to block 420 to determine whether the service period 136 is over. Otherwise, in response to determining that the buffer 118 does not comprise an isochronous request, the arbiter 124 may cause the memory interface 120 to service no request thus allowing a slice 138 of the asynchronous portion 144 to go unused. In particular, the arbiter 124 in block 428 may wait for a predetermined number (e.g. 2) of clock cycles to pass and then may return to block 420 to determine whether the current service period 136 is over.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

1. A method comprising
setting a deadline of a service period to define an asynchronous portion prior to the deadline and an isochronous portion after the deadline,
servicing asynchronous requests during the asynchronous portion of the service period, and
servicing isochronous requests during the isochronous portion of the service period.

2. The method of claim 1 further comprising servicing an isochronous request during the asynchronous portion of the service period in response to determining that no asynchronous request is available to service.

3. The method of claim 1 further comprising
servicing an isochronous request during the asynchronous portion of the service period in response to determining that no asynchronous request is available to service, and
updating the deadline to reduce the isochronous portion of the service period and to increase the asynchronous portion of the service period in response to servicing the isochronous request during the asynchronous portion of the service period.

4. The method of claim 1 further comprising determining that the asynchronous portion of the service period is over in response to determining that a specified number of slices of the service period have passed.

5. The method of claim 1 further comprising determining that the asynchronous portion of the service period is over in response to determining that a specified number of clock cycles have passed.

6. The method of claim 1 further comprising determining that the service period is over in response to determining that a specified number of slices of the service period have passed.

7. The method of claim 1 further comprising determining that the service period is over in response to determining that a specified number of clock cycles have passed.

8. A machine readable medium comprising a plurality of instructions that in response to being executed result in a computing device
determining a service period for an arbiter of asynchronous requests and isochronous requests, and
setting a deadline that divides the service period into an asynchronous portion for servicing asynchronous requests and a following isochronous portion for servicing isochronous requests.

9. The machine readable medium of claim 8 wherein the plurality of instructions further result in the computing device setting a duration of the service period based upon an isochronous time period of the computing device and a latency requirement of the isochronous requests.

10. The machine readable medium of claim 8 wherein the plurality of instructions further result in the computing device setting a duration of the service period based upon an isochronous time period of the computing device, a latency requirement of the isochronous requests, and a maximum payload size of the isochronous requests.

11. The machine readable medium of claim 8 wherein the plurality of instructions further result in the computing device
determining how many isochronous requests are required to be serviced within the service period of the computing device,
setting the deadline such that isochronous portion is sufficient to service the determined number of isochronous requests per the service period.

12. The machine readable medium of claim 8 wherein the plurality of instructions further result in the computing device
determining a worse-case service time for an isochronous request based upon a maximum payload size for an isochronous request,
determining how many isochronous requests are required to be serviced within the service period of the computing device,
setting the deadline such that the duration of the isochronous portion is at least equal to the worse-case service time multiplied by the the determined number of isochronous requests per the service period.

13. A memory controller comprising
a buffer to store asynchronous requests and isochronous requests,
a memory interface to service the asynchronous requests and isochronous requests of the buffer, and
an arbiter to select asynchronous requests for the memory interface to service during an asynchronous portion of a service period and to select isochronous requests for the memory interface to service during an isochronous portion of the service period that follows the asynchronous portion.

14. The memory controller of claim 13 wherein the arbiter selects an isochronous request for the memory interface to service during the asynchronous portion of the service period in response to determining that no asynchronous request is available to service.

15. The memory controller of claim 13 further comprising a deadline register to store a deadline that divides the service period into the asynchronous portion and the isochronous portion.

16. The memory controller of claim 15 wherein the arbiter
selects an isochronous request for the memory interface to service during the asynchronous portion of the service period in response to determining that no asynchronous request is available to service, and
updates the deadline of the deadline register to account for the isochronous request serviced during the asynchronous period.

17. The memory controller of claim 15 wherein the arbiter
selects an isochronous request for the memory interface to service during the asynchronous portion of the service period in response to determining that no asynchronous request is available to service, and
updates the deadline of the deadline register to reduce the isochronous portion of the service period and to increase the asynchronous portion of the service period in response to memory interface servicing the isochronous request during the asynchronous portion of the service period.

18. The memory controller of claim 13 further comprising
a service period register specifying a number of slices that comprise the service period,
a slice duration register specifying a duration of the slices that comprise the service period, wherein
the arbiter determines that the asynchronous portion of the service period is over in response to determining that a specified number of slices of the service period have passed.

19. The memory controller of claim 13 further comprising a service period register specifying a number of clock cycles that comprise the service period, wherein
the arbiter determines that the asynchronous portion of the service period is over in response to determining that a specified number of clock cycles of the service period have passed.

20. A system comprising
an asynchronous device to issue asynchronous requests,
an isochronous device to issue isochronous requests, and
an arbiter to select asynchronous requests for servicing during an asynchronous portion of a service period and to select isochronous requests for servicing during an isochronous portion of the service period that follows the asynchronous portion.

21. The system of claim 20 wherein the arbiter selects an isochronous request for servicing during the asynchronous portion of the service period in response to determining that no asynchronous request is available to service.

22. The system of claim 21 wherein the arbiter reduces the isochronous portion of the service period and increases the asynchronous portion of the service period in response to selecting the isochronous request for servicing during the asynchronous portion of the service period.

23. The system of claim 22 wherein the arbiter determines that the asynchronous portion of the service period is over after a specified number of slices of the service period have passed.

24. The system of claim 22 wherein the arbiter determines that the asynchronous portion of the service period is over after a specified number of clock cycles of the service period have passed.
